(19) United States
(12) Patent Application Publication
(10) Pub. No.: US 2007/0203660 A1
(43) Pub. Date: Aug. 30, 2007

(54) Systems and related methods for managing data corresponding to environmental inspections, and for dynamically generating an inspection report

(76) Inventors: Ed North, Poulsbo, WA (US); Eric Evans, Port Orchard, WA (US)

Correspondence Address: John M. Janeway;GRAYBEAL JACKSON HALEY LLP, Suite 350, 155 - 108th Avenue NE, Bellevue, WA, 98004-5973, US

(21) Appl. No.: 11/712,266

(22) Filed: Feb. 27, 2007

Related U.S. Application Data
(60) Provisional application No. 60/777,849, filed on Feb. 28, 2006.

(51) Int. Cl. G01N 37/00

(52) U.S. Cl. 702/83; 210/85; 422/119

(57) ABSTRACT

A system is provided for easily and efficiently managing a compliance monitoring process and for dynamically generating an inspection report. The system includes a database that contains data that identifies specific information about a device, system or environmental element that is located and to be inspected at a particular site. The database also contains data that identifies specific information to be obtained during an inspection of the specific devices, systems or environmental elements at a particular site. Furthermore, the database can be easily updated to correspond with changes in the laws and/or regulations applicable to a particular site, or to correspond with changes to the devices, systems or environmental elements located at a particular site. The inspection report includes the data from the database, and is dynamically generated soon before an inspector inspects a device, system or environmental element at a particular site. By generating an inspection report soon before an inspection is to occur, and using data from a database that is updated, the inspection report can provide just specific, current data required for the specific inspection to be performed.

### CROSS REFERENCE TO RELATED APPLICATIONS

This application claims priority from commonly owned U.S. Provisional Patent Application 60/777,849, filed 28 Feb. 2006, and titled DYNAMIC COMPONENT REPORT GENERATION, VALIDATION AND NOTIFICATION, presently pending, which is incorporated herein by reference in its entirety and for all its teachings and disclosures.

### BACKGROUND

Many environmental government agencies are responsible for monitoring devices and systems located within their jurisdiction for compliance with the laws and regulations governing many environmental issues. For example, a state's Department of Ecology may have jurisdiction over wastewater systems, such as a sewer system, that handle a high volume of wastewater; a state's Department of Health may have jurisdiction over wastewater systems that handle a moderate volume of wastewater; and a county or local office may have jurisdiction over wastewater systems, such as a septic system, that handle a low volume of wastewater. Many environmental government agencies are also responsible for monitoring the quality of environmental elements, such as water, soil and air, located within their jurisdiction. For example, a state's Department of Health may also have jurisdiction over the quality of the drinking water provided at a site.

Before an agency can assess the compliance of a device, system or environmental element, inspectors inspect the device, system or environmental element to obtain the data required to assess compliance. Once obtained, the data is provided to the agency. When performing an inspection, an inspector uses an inspection report to focus the inspector's inspection and facilitate the transfer of the data to the agency. An example of a typical inspection report is shown in FIGS. 1A-1B, which show respective pages of a three page inspection report 20. The inspection report 20 basically includes two types of data. The first type of data identifies information about the location of the site and the devices, systems and or environmental elements located at the site to be inspected. The second type of data identifies information that the inspector needs to obtain during his/her inspection. After the inspector completes the inspection, the inspector provides the agency the completed inspection report. The agency, then inputs the data from the inspection report into a database, and saves the data.

Unfortunately, the typical inspection report 20 is cumbersome and time consuming to use. The inspection report 20 is cumbersome because the inspection report is often a generic template that contains more general data about the devices, systems, or environmental elements than is necessary, and not enough specific data about the specific devices, systems and environmental elements at a particular site that may be necessary to complete a thorough inspection. For example, the inspection report 20 includes data identifying information about a pump 22, alarm systems and controls 24 and 26, respectively, and an overflow storage tank 28. If the septic system being inspected does not include these devices, the inspector still has to address them on the inspection report. As another example, the inspection report 20 does not include an indication that the tank has a unique inspection window, or that a specific disassembly instruction must be followed to inspect the septic system. Thus, the inspector has to spend time figuring out how to complete the inspection, or the inspector might not complete or might incorrectly complete the inspection.

The inspection report 20 is time consuming to use because the inspection report 20 is often printed on paper, and thus, the data that identifies information that the inspector needs to obtain during his/her inspection is also printed on paper. Consequently, when either the inspector or an agency employee enters the data from a completed inspection report into a database, the inspector or agency employee often enters the data manually. Furthermore, because the inspection report 20 is a generic template, the inspector will often write notes on the report discussing specific issues that he encountered during the inspection. These notes often include valuable information about the specific device, system, or environmental element inspected, but because they are handwritten, the agency might not save the inspector's notes in the agency's database. And, if the notes were to be saved, the agency would often have a difficult time finding and reviewing the notes to generate an historical perspective and/or a trend in the compliance of a specific device, system or environmental element at a particular site because the text of the inspector's notes would be very difficult to search with a search engine.

### SUMMARY

In one aspect of the invention, a method for managing information generated from an environmental inspection includes: 1) retrieving, from a database, a first type of data that identifies the location of an environmental site to be inspected, and at least one of the following subjects located and to be inspected at the environmental site: a) a device, b) a system, and c) an environmental element; 2) retrieving, from a database, a second type of data that identifies information to be obtained from the inspection; 3) dynamically generating an inspection report that includes the first type data, and the second type of data; and 4) providing the inspection report to an inspector to facilitate the inspector's inspection of the environmental site.

With the dynamically generated inspection report, an inspector can receive an inspection report that only provides specific, current data required for the specific inspection to be performed. Thus, the inspector can avoid wasting time addressing irrelevant issues identified on a generic report, and can avoid wasting time figuring out a specific processes required to perform an inspection or to access a system component for inspection. In addition, a dynamically generated inspection report can provide data that identifies very specific, and often valuable, information to be obtained during an inspection. Thus, the governing agency's database is more likely to include the specific and often valuable information to help the agency more accurately assess the compliance of a device, system, or environmental element.

### BRIEF DESCRIPTION OF THE FIGURES

FIGS. 1A-1C combined show a conventional inspection report.

FIG. 2 is a schematic diagram of a system, according to an embodiment of the invention.

FIGS. 3A-3C combined show an inspection report dynamically generated by the system 30 in FIG. 2, according to an embodiment of the invention.

FIG. 4 is a schematic diagram of an inspection report generator, according to an embodiment of the invention.

FIG. 5 is a flowchart of a process for inspecting an environmental site, according to an embodiment of the invention.

FIG. 6 is a flowchart of a process for validating an inspection report and for notifying an appropriate entity of a result of the validation process, according to an embodiment of the invention.

FIG. 7 is a flowchart of a process for a regulatory agency to review and track inspection results, or update data used to dynamically generate an inspection report, according to an embodiment of the invention.

FIG. 8 is a flowchart of a process for a manufacturer to review and update data used to dynamically generate an inspection report, according to an embodiment of the invention.

### DESCRIPTION

Various modifications to the disclosed embodiments will be readily apparent and the generic principles herein may be applied to other embodiments and applications without departing from the spirit and scope of the present discussion. Thus, the present discussion is not to be limited to the embodiments shown, but is to be accorded the widest scope consistent with the principles and features disclosed herein. For example, a computer-readable storage medium does include a signal that can carry a program that, when executed by a computer, performs a function.

The present invention provides a system for easily and efficiently managing a compliance monitoring process and for dynamically generating an inspection report. The system includes a database that contains data that identifies specific information about a device, system or environmental element that is located and to be inspected at a particular site. The database also contains data that identifies specific information to be obtained during an inspection of the specific devices, systems or environmental elements at a particular site. Furthermore, the database can be easily updated to correspond with changes in the laws and/or regulations applicable to a particular site, or to correspond with changes to the devices, systems or environmental elements located at a particular site. The inspection report includes the data from the database, and is dynamically generated soon before an inspector inspects a device, system or environmental element at a particular site. By generating an inspection report soon before an inspection is to occur, and using data from a database that is updated, the inspection report can provide just specific, current data required for the specific inspection to be performed.

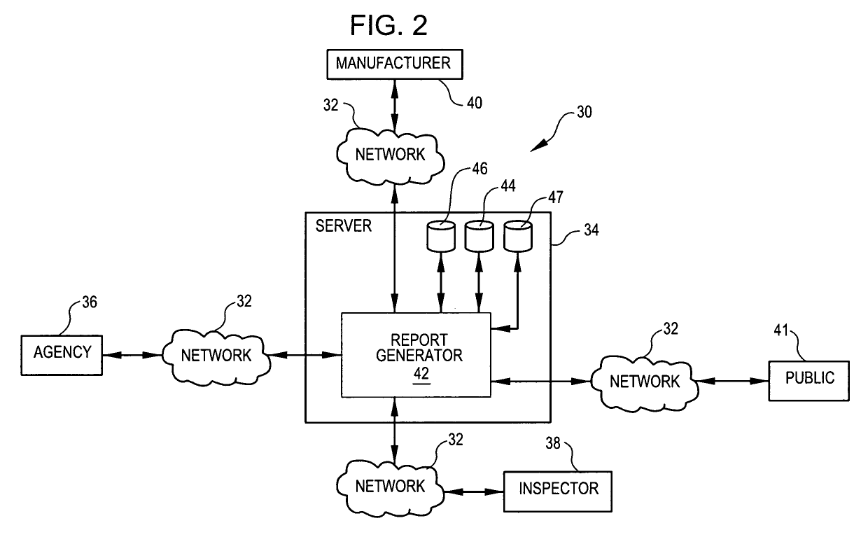

FIG. 2 is a schematic diagram of a system 30, according to an embodiment of the invention. The system 30 includes, a communications network 32, and a server 34 for dynamically generating an inspection report and for storing the data used to generate the inspection report and the data obtained from a particular inspection. The network 32 can be any desired network, for example, the internet, any desired intranet, a phone network, or a postal network. The system 30 also includes one or more agency computers 36 (only one shown here) that can communicate with the server 34 via a portion of the network 32 to allow an agency to retrieve data obtained during an inspection and to update the data used to dynamically generate an inspection report. In addition, the system 30 also includes one or more inspector computers 38 (only one shown here) that allows, via a portion of the network 32, an inspector to retrieve a dynamically generated inspection report, to provide the server 34 the data obtained from an inspection, and to update the data used to dynamically generate an inspection report.

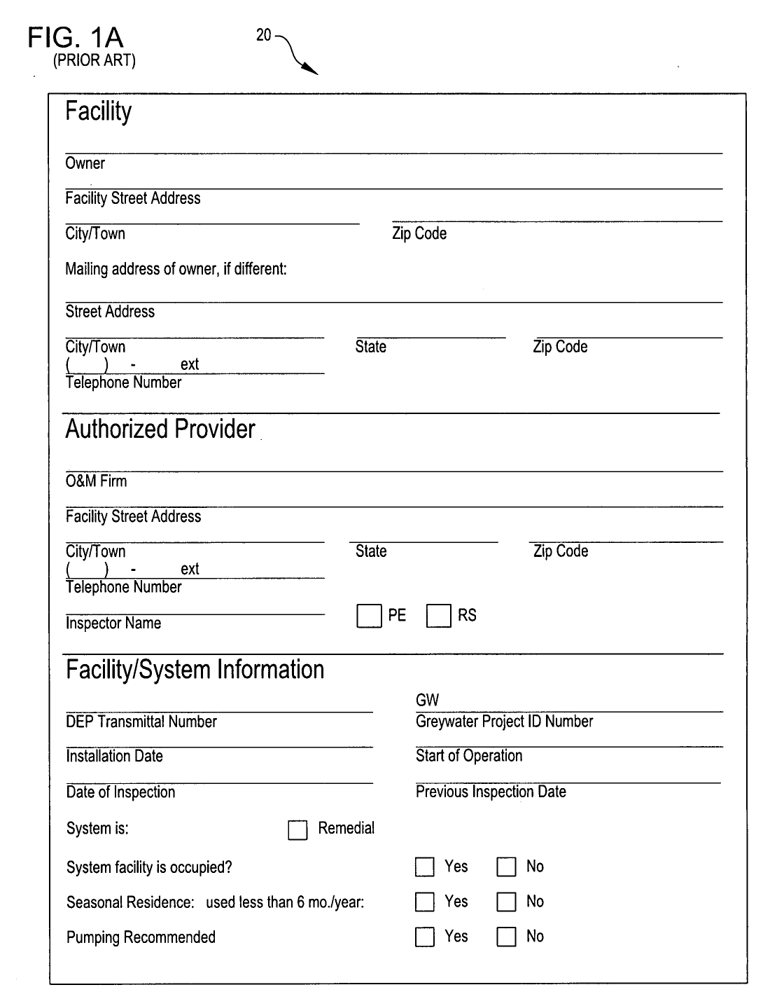

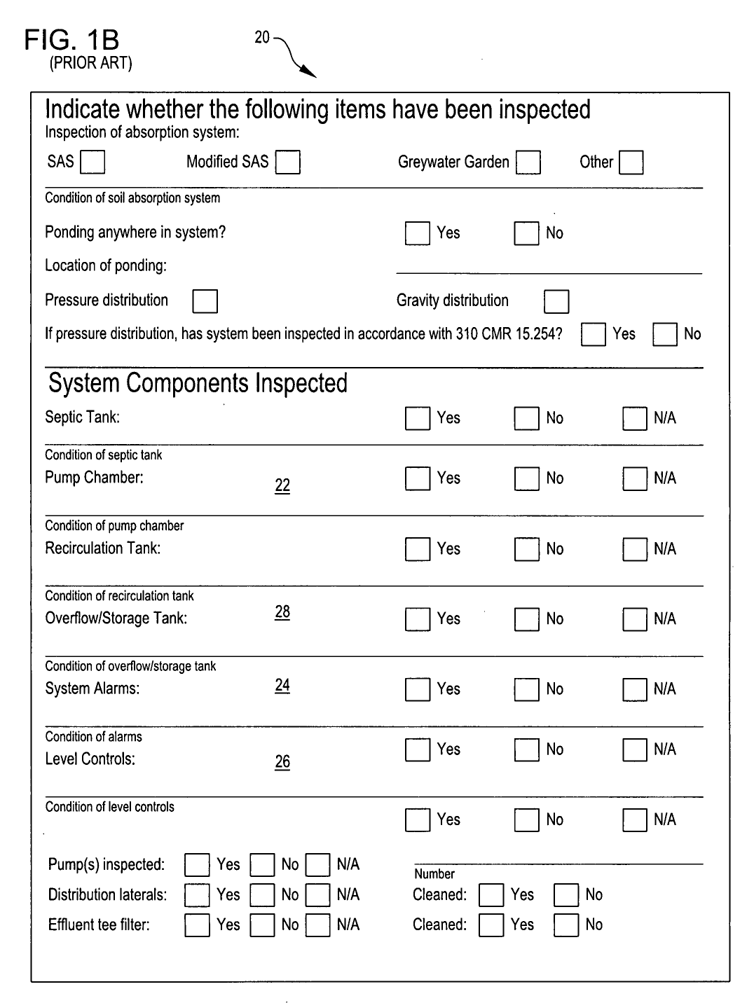

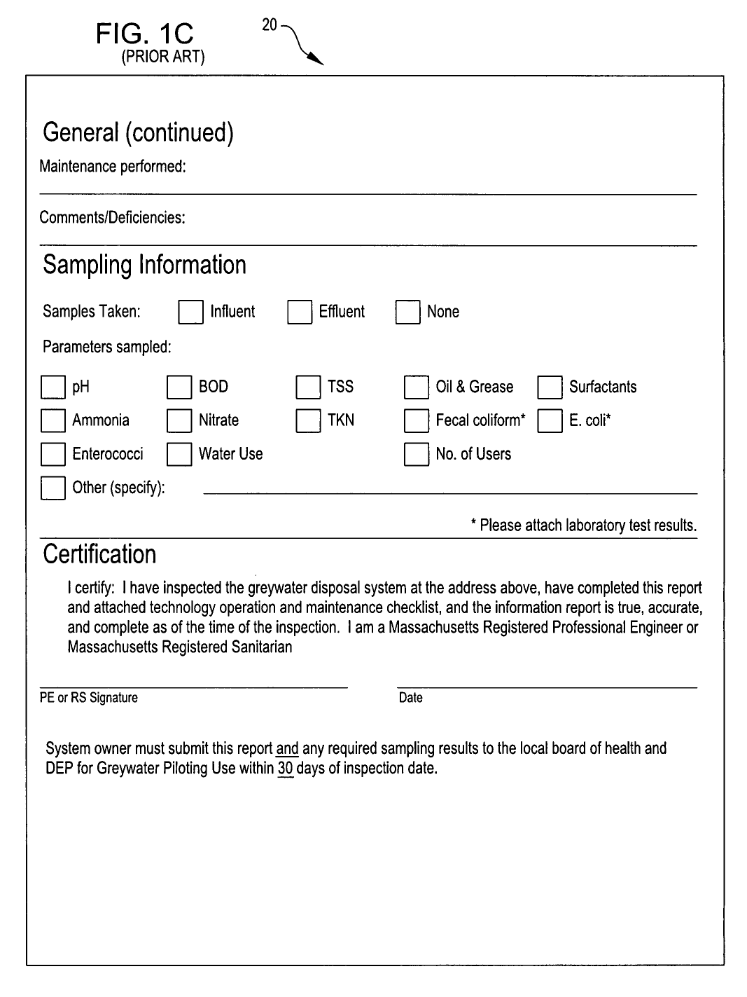

In this and certain other embodiments of the system 30, the system 30 also includes one or more manufacturer computers 40 (only one shown here), and one or more public computers 41 (only one shown here). The one or more manufacturer computers 40 allow a manufacturer to update, via a portion of the network 32, specific information about a device or system that it manufactures. This may be desirable when a device or system to be inspected includes an uncommon feature that must be used or disabled to complete an inspection of the device or system, or when there is an update to the specific information to be obtained during an inspection of the specific device or system. The one or more public computers 41 allow a member of the public, such as the owner of an inspected environmental site, to view, via a portion of the network 32, data obtained from an inspection, and, if desired, compliance assessments performed by the agency. This may be desirable to help keep actions taken by the agency open to public review. Although shown in FIG. 1, other embodiments of the system do not include one or more manufacturer computers 40 or one or more public computers 41.

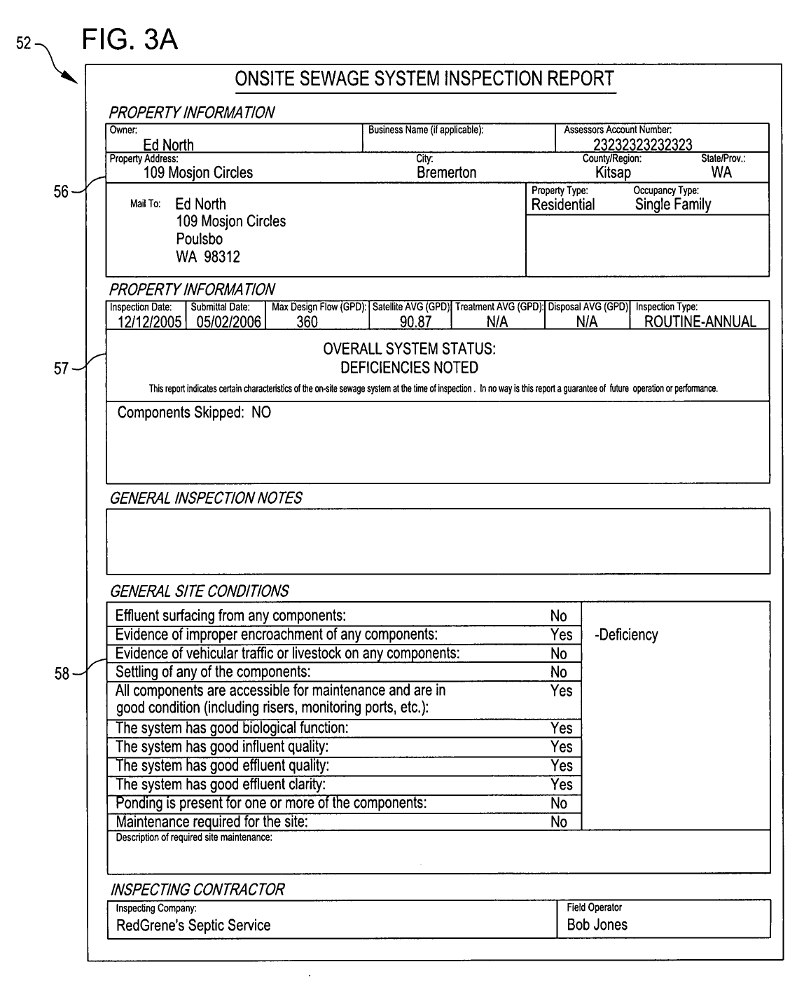

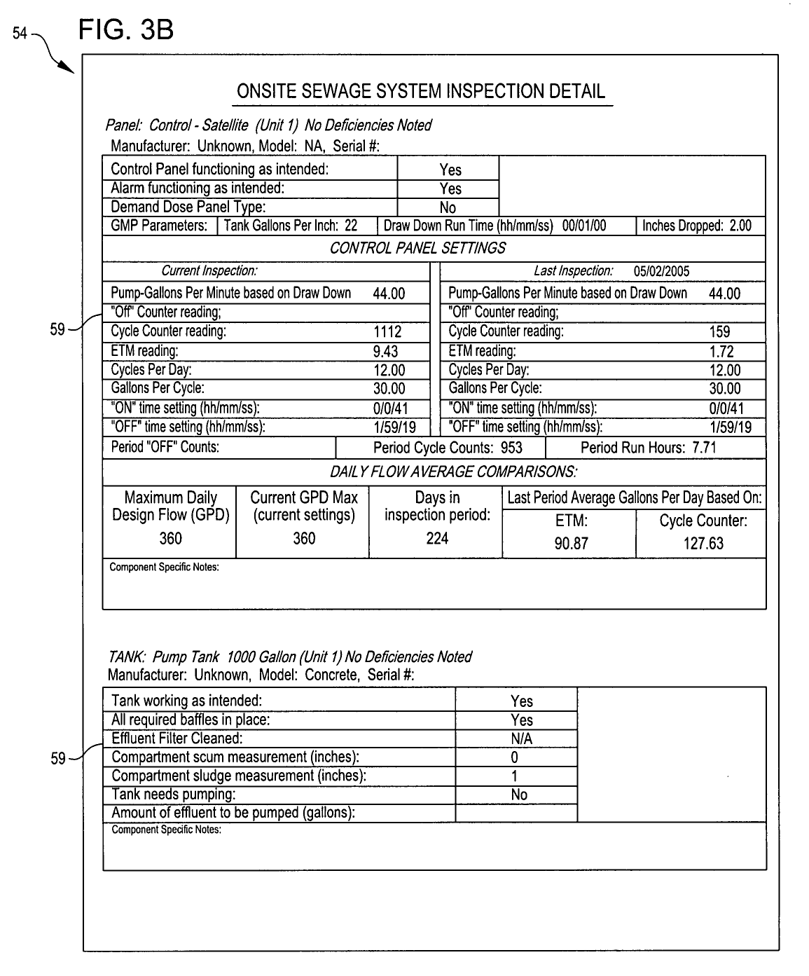

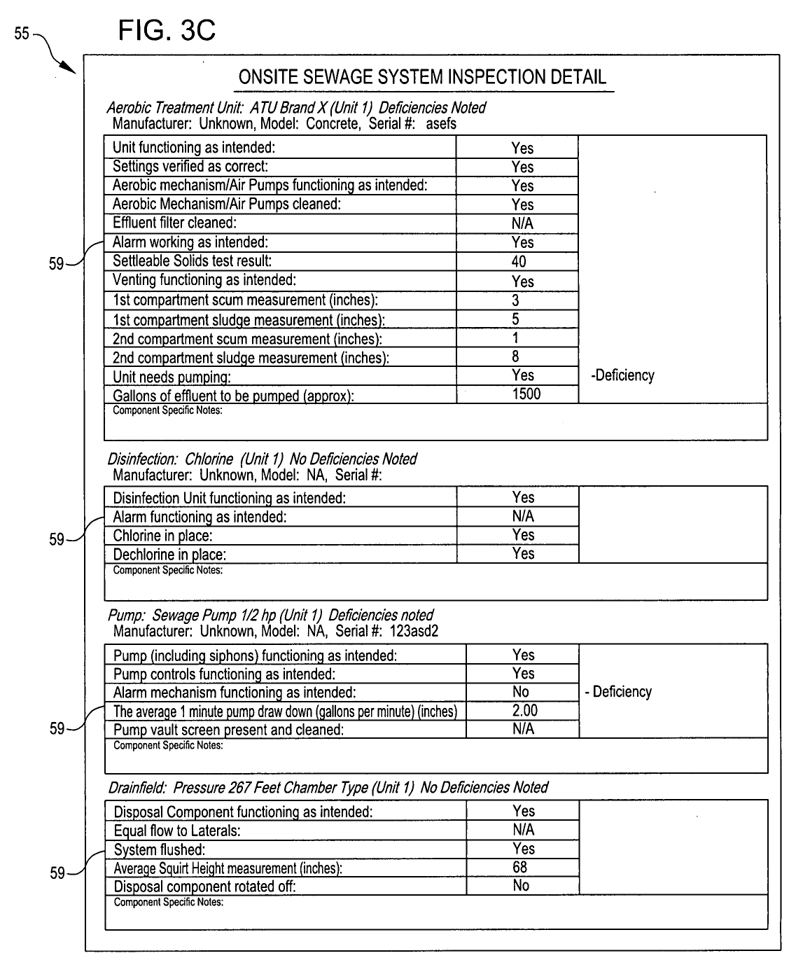

The server 34 includes a report generator 42 to dynamically generate an inspection report, an example of which is discussed in further detail in conjunction with with FIGS. 3A-3B, and a database that contains two types of data that the inspector requires to complete an inspection. The first type of data includes information that identifies the location of an environmental site, and the one or more devices, systems or environmental elements that are located and to be inspected at the environmental site. For example, In some embodiments, the first type of data includes the address of a residential dwelling, and identifies the type and size of the septic system that the residents use to treat wastewater, and the devices or components of the septic system, such as a pump (if used) and the type and size of the system's drain field. In other embodiments, the first type of data may include all of the previously discussed information and a schematic showing the location of the septic tank on the site and any particular design information that the inspector might need to know to facilitate his inspection of the septic system.

The second type of data includes data that identifies the information that the inspector needs to obtain during the inspection. For example, in some embodiments, the second type of data includes queries on the overall condition and flow rate of a septic system, and more particularly to the volume of the septic tank, how well the drain field and/or pump operate and whether or not there is standing water in the drain field. In other embodiments, the second type of data includes queries on the concentration levels of one or more specific chemicals in drinking water provided to the residential dwelling.

In this and certain other embodiments, the server 34 includes three databases 44, 46, and 47. The database 44 contains the first type of data, and the database 46 contains the second type of data. The database 47 contains a third type of data that includes information that lists available devices, systems, and their respective specific information, which the report generator 42 can use to update the first type of data. The third type of data is similar to the first type except the third type of data does not include information that associates a specific device, system or environmental element with a particular environmental site.

With the different types of data contained in the different databases 44, 46 and 47, a level of security can exist on the server to help maintain the integrity of the three types of data. For example, in some embodiments, an inspector, via the inspector computer 38, may only be allowed to access the first type of data contained in the database 44 to update the data as required by a change in the system or device located at a site. An agency, via the agency computer 36, may only be allowed to access the second type of data contained in the database 46 to update the data as required by a change in the laws and/or regulations. And, a manufacturer, via the manufacturer computer 40, may only be allowed to access the third type of data contained in the database 47 to update the data as required by a change in the design of an existing device or system, or by an introduction of a new device or system.

In other embodiments, the database 44 may contain both the first and second types of data, and the database 46 may contain data that identifies the information currently required to be obtained from an inspection. In such embodiments, the report generator can compare the data in database 44 with the current data in the database 46, and revise the data in database 44 as required to dynamically generate a current inspection report. In still other embodiments, the server can include a single database that contains the two types of data required for the inspector to perform an inspection.

Still referring to FIG. 2, the report generator 42 can dynamically generate an inspection report at any time before the inspector completes an inspection. For example, the inspector can have an inspection scheduled for a certain day and can have the server dynamically generate an inspection report a week before the scheduled inspection. Thus, the inspection report that the inspector uses for an inspection should identify the current devices, systems and/or environmental elements to be inspected at a site. As another example, the inspector can have the server dynamically generate an inspection report while the inspector is performing an inspection to accommodate for a modification to a system or a device or component of a system that was not previously accounted for in the databases 44 and 46. Thus, the inspector can efficiently adapt to changes in his required inspection protocol.

With the system 30, an agency or entity that is responsible for monitoring devices, systems and environmental elements within a jurisdiction can easily and efficiently manage the monitoring process and the information that is obtained and generated during the process. In addition, an inspector responsible for inspecting devices, systems and environmental elements located at an environmental site, can obtain an inspection report that includes current and specific information about the devices, systems or environmental elements to be inspected at a particular site.

Still referring to FIG. 2, the server 34 can include any desired hardware and any desired corresponding software that allows one to control the hardware. Furthermore, the server 34 can include any desired software that enables the server 34 to maintain the databases, dynamically generate an inspection report, and communicate with one or more of the agency, inspector, and/or manufacturer computers 36, 38 and 40, respectively. For example, in this and certain other embodiments, the server 32 is a conventional server that executes a conventional operating system software to support the hardware and software used by the server 34. The server 34 also executes SQL software to maintain and retrieve data in the databases.

Still referring to FIG. 2, the agency, inspector, and manufacturer computers 36, 38, and 40, respectively, each can include any desired hardware and any desired corresponding software that allows one to control the hardware. For example, in this and certain other embodiments, the agency computer 36, the inspector computer 38, and the manufacturer computer 40 are each conventional personal computers that execute conventional operating system software to support the respective hardware and respective software that each of the respective computers 36, 38, and 40 use.

FIGS. 3A-3C combined show an inspection report 50 dynamically generated by the system 30 in FIG. 2, according to an embodiment of the invention. FIG. 3A shows a first page 52 of the three page inspection report 50. FIG. 3B shows a second page 54 of the three page inspection report 50. And FIG. 3C shows a third page 55 of the three page inspection report 50. The inspection report 50 includes current and specific information about the devices, systems or environmental elements to be inspected at a particular site. The inspection report 50 also identifies specific information to be obtained from an inspection.

For example, in this and certain other embodiments of the inspection report 50, the first page 52 includes a Property Information section 56 that identifies the specific address of the site to be inspected, an Inspection Summary section 57 that summarizes the results of the inspection, and a general site conditions section 58 that identifies general information to be obtained form an inspection. The second and third pages page 54 and 55, respectively, list the specific devices and systems that are located at the site and that the inspector is to inspect. The pages 54 and 55 also include specific information 59 grouped with its respective device and system, that identifies the make and model of each device and system, and that is to be obtained from an inspection of the device and system.

Compared to the inspection report 20 FIG. 1, an inspector, after reviewing the inspection report 50, will have a better idea of the devices and system that he will have to inspect, and thus can be better prepared for the specific inspection. And the agency, after reviewing the inspector's completed inspection report, will be able to receive more detailed information about the condition of the devices and systems at the specific site, and thus perform a more complete compliance assessment.

Other inspection reports can be dynamically generated by the system 30. For example, the system 30 can dynamically generate an inspection report specific to a chemical manufacturer's wastewater and toxic byproduct disposal systems. Furthermore, other types of reports can be generated by the system 30 that help an agency easily and efficiently manage a compliance monitoring process, and that help an inspector perform inspections. For example, the system 30 can keep track of scheduled events, such as inspections and updating, generate a reminder for the event, and send the reminder via the network 34 to the appropriate entity. The system 30 can also generate, send and track notification reports that notify the appropriate entity of the results of the agencies compliance assessment. As another example, the system 30 can manage an agency's permit process, as desired. Permits are often required to add a new device or system, to add a new use to an existing device or system, or to modify an existing device or system. The system 30 can track applications for a permit and provide status updates to an application for a permit. As another example, the system 30 can also provide reports that show trends over time relative to a specific site, inspector and/or manufacturer.

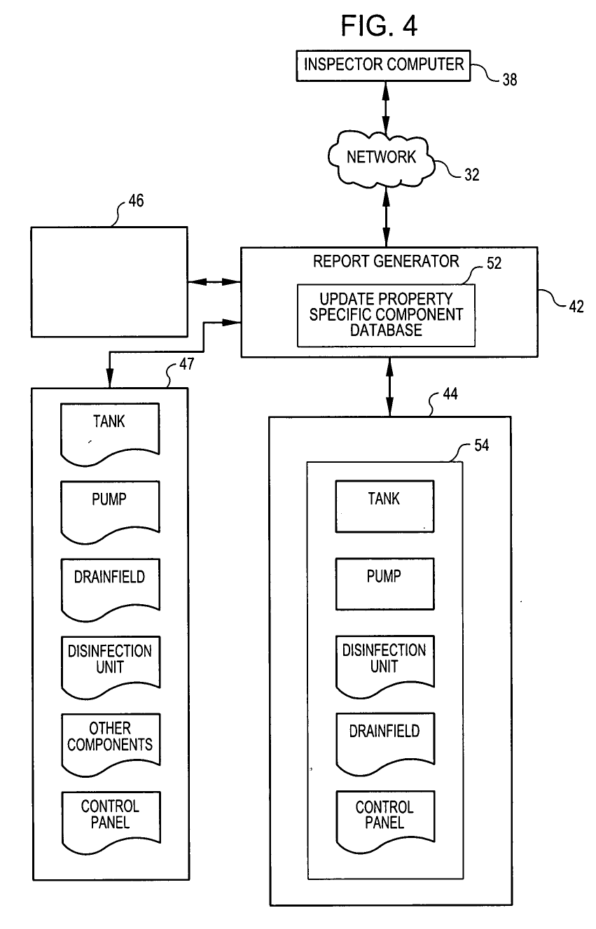

FIG. 4 is a schematic diagram of the report generator 42 in FIG. 2, according to an embodiment of the invention. The process by which the report generator 42 dynamically generates an inspection report, such as the inspection report 50 in FIGS. 3A-3B, can be any desired process.

For example, in this and certain other embodiments, the report generator 42 generates an inspection report for a particular site by first retrieving from the database 44 a file 54 having the first type of data for the particular site. If the report generator 42 can not find a file 54 for the particular site, then the report generator 42 communicates this to the inspector computer 38, and discontinues the dynamic generation of an inspection report for the particular site. If, however, the report generator 42 does find a file 54 for the particular site, then the report generator 42 reads the data that identifies the specific devices, systems, or environmental elements to be inspected at the site. Next, the report generator 42 retrieves from the database 46 the second type of data for the specific devices, systems or environmental elements located in a specific jurisdiction, and reads the data. Then, the report generator 42 combines the first type of data with the second type of data to dynamically generate an inspection report, and provides the report to the inspector computer 38.

The report may be provided to the inspector in any desired manner. For example, in this and certain other embodiments, the report may be transmitted electronically over the network 32, and saved electronically by the inspector computer 38 for future use. In other embodiments, the report may be printed and faxed or mailed to the inspector computer 38 for future use.

If the inspector discovers that the inspection report does not accurately reflect the devices, systems or environmental elements that he/she is to inspect at a particular site, then the inspector can revise the inspection report. For example, in this and certain other embodiments, the inspector can communicate with the report generator 42 via a laptop computer (not shown) and the internet. Once connected, the inspector can have the update component 52 of the report generator 42 revise the first type of data in the database 44. To do this, the inspector provides the update component 52 data that identifies the device, system or environmental element to be removed or added. If the device, system or environmental element is to be removed, then the update component 52 retrieves the first type of data, and deletes the information specific to the device, system or environmental element to be removed. If the device, system or environmental element is to be added, then the update component 52 retrieves the appropriate third type of data from the database 47, and reads the data. The update component 52 than retrieves the first type of data from the database 44 to be revised, and adds the third type of data to update the first type of data.

In other embodiments, the report generator 42 can dynamically generate an inspection report by first retrieving from the database 44 previously used first and second type data associated with a particular site, and reading the data. Next, the generator can retrieve from another database first and second type data that is current, and read this current data. Then, the generator can compare both sets of data. If the current data is not different than the previously used data, the report generator uses the previously used data to dynamically generate an inspection report. If, however, the current data is different than the previously used data, the report generator will combine the two sets of data to dynamically generate an inspection report that includes the current data.

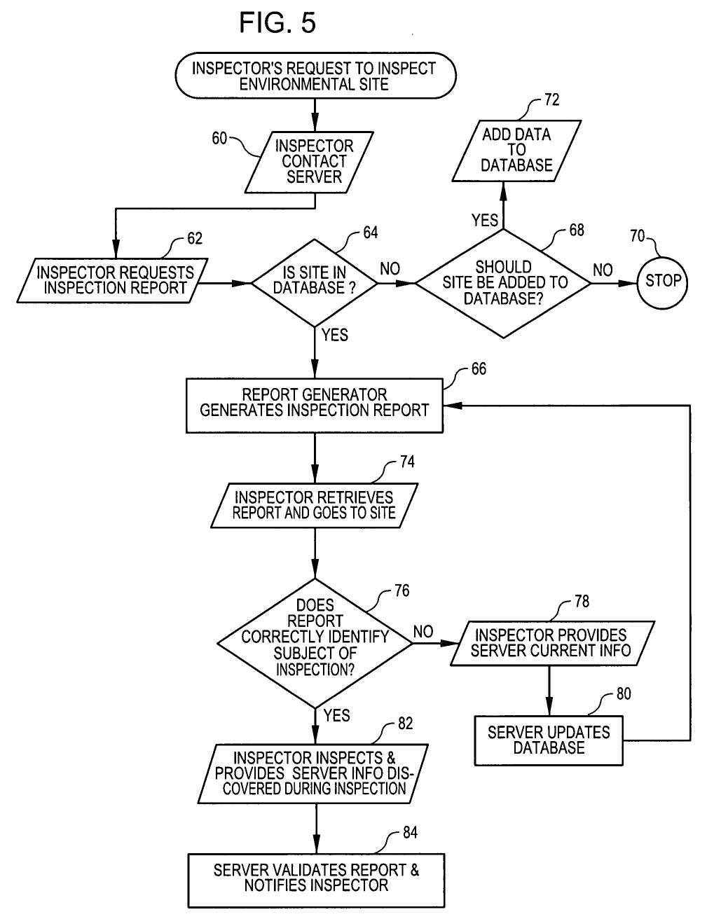

FIG. 5 is a flowchart of a process for inspecting an environmental site, according to an embodiment of the invention. In this and certain other embodiments, the process begins with an inspector establishing communication between his inspector computer 38 (FIG. 2) and the server 34 (FIG. 2) via the network 32 (FIG. 2).

After communication is established at step 60, the inspector, at step 62, requests from the server 32 an inspection report for the particular site to be inspected. The server 32 then executes the report generator 42 (FIG. 2). As discussed in conjunction with FIG. 4, at step 64, the report generator 42 determines whether or not data of the first type for the particular site exists in a database of the server 32. If the data does not exist in a database of the server 32, then the server 32 informs the inspector computer 38 as discussed in conjunction with FIG. 4. Then at step 68, a decision whether or not to generate and save data of the first type for the particular site is made. If the decision is no, then at step 70 the inspection process stops. If the decision is yes then at step 72 data of the first type is generated for the particular site and saved in a database of the server 32.

If the report generator 42 does find data of the first type for the particular site, then at step 66, the report generator dynamically generates an inspection report as discussed in conjunction with FIG. 4. Next, at step 74, the inspector retrieves the dynamically generated inspection report and goes to the particular site that he/she is to inspect. At step 76, the inspector determines whether or not the dynamically generated inspection report accurately identifies the devices, systems and environmental elements located at the site and that are to be inspected. If the inspection report is not accurate, then at step 78, the inspector requests from the report generator 32 a revised dynamically generated inspection report. Then, at step 80, the report generator 42 updates the first type of data for the particular site, as discussed in conjunction with FIG. 4. Once this update is completed, the report generator 42 dynamically generates at step 66 another inspection report that is current.

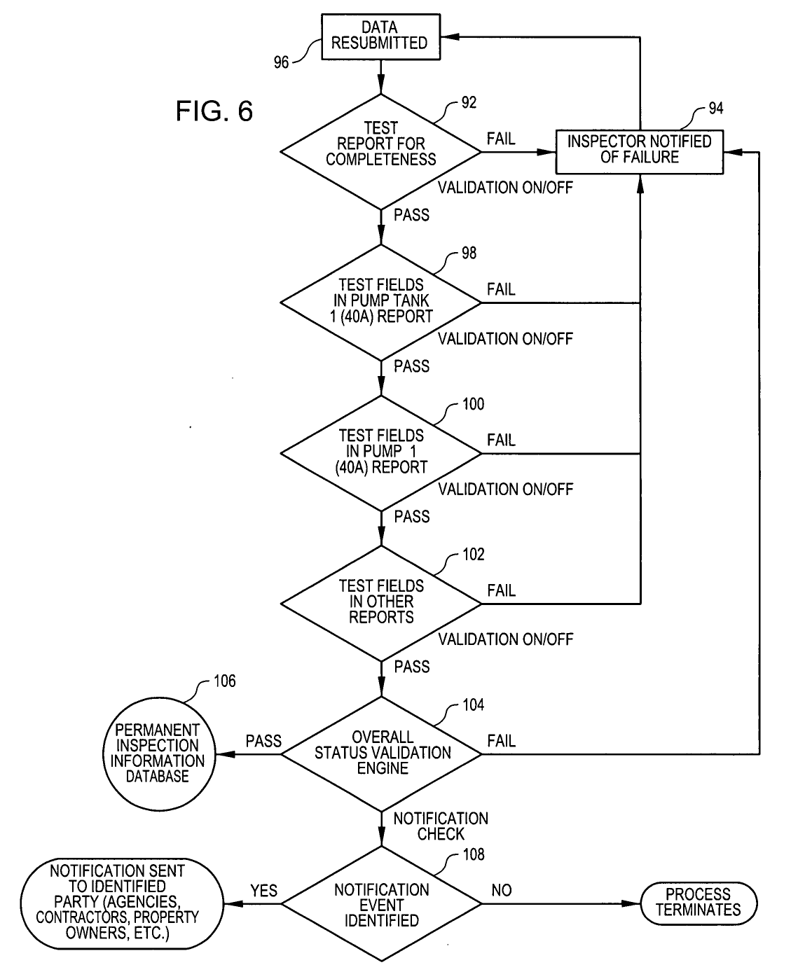

If, however, the first generated inspection report (not the updated inspection report) is accurate, then at step 82, the inspector inspects the devices, systems or environmental elements and records his findings on the inspection report, and provides the server 32 the data included in the completed inspection report. Next at step 84, and as discussed in greater detail in conjunction with FIG. 6, the server 32 validates the completed inspection report and notifies the appropriate entities.

FIG. 6 is a flowchart of a process for validating a completed inspection report and for notifying an appropriate entity of a result of the validation process, according to an embodiment of the invention. In this and certain other embodiments, the validation and notification process begins when the server 32 receives data from a completed inspection report.

The data received from the inspector is entered into the system and tested, at step 92, to determine if all of the required data was provided. If the inspection report fails this test, then at step 94 the server 32 notifies the inspector. The notification can be made by any desired means, such as via the internet, intranet, or by phone call. After being notified of the failure, the inspector determines the cause for the failure and, if appropriate, completes the inspection and submits the data associated with newly completed inspection report to the server 32. If, however, the failure was not caused by an incomplete inspection report, then at step 96, the inspector resubmits the data associated with the previously completed inspection report to the server 32. The server 32 then tests the newly submitted data to determine if all of the data to be obtained during the inspection was provided.

If the inspection report passes the first test, then at steps 98-102, the data obtained during the inspection is reviewed to determine if the data makes sense. For example, if a specific portion the data contains numbers when it should contain letters, or if specific data is present that is triggered by the presence of other data. If the inspection report fails any of these tests, then at step 94 the server notifies the inspector, and the process for correcting the failure described in the previous paragraph is performed again.

If the data included in the inspection report does make sense, then at step 104, the overall conclusion of the inspection report is reviewed to determine whether or not it agrees with the conclusion of the inspection of each of the specific devices, systems or environmental elements. The overall conclusion can not be more favorable than the least favorable conclusion of one or more of the specific devices, systems or environmental elements. For example, an inspection report that shows the pump located a site as a failing the inspection, must show a failure for the overall conclusion of the inspection. The inspection report can not show a pass for the overall conclusion of the inspection. If the overall conclusion does not agree with the conclusion of each of the specific devices, systems or environmental elements, then the server 32 notifies the inspector at step 94, and the process for correcting the failure described elsewhere herein is performed again.

If the overall conclusion does agree with the conclusion of each of the specific devices, systems or environmental elements, then the data in the inspection report is saved in a database 106 for future use by an agency. At step 108, the server 32 checks to see if one or more appropriate entities should be notified of the results of the validation process or the specific results of the inspection. If one or more appropriate entities should be notified, then the server 32 notifies them. If not, then the validation and notification process terminates.

Other embodiments of the process are possible. For example, the process may not include a notification process after the inspection report passes the validation process.

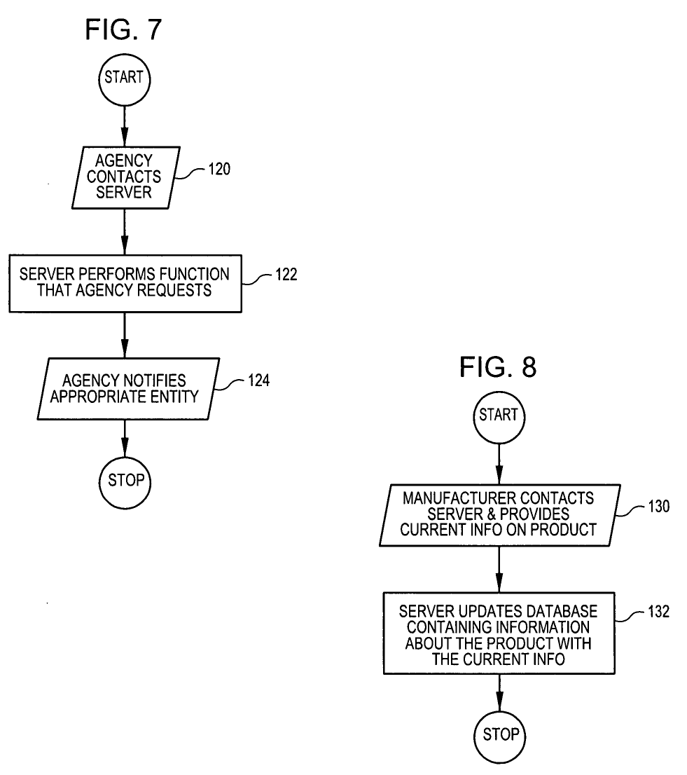

FIG. 7 is a flowchart of a process for a regulatory agency to review and track inspection results, or update data used to dynamically generate an inspection report, according to an embodiment of the invention. In this and certain other embodiments, the review, track or update process begins when the agency computer 36 (FIG. 2) communicates with the server 32 (FIG. 2) at step 120. After communication has been established, the agency requests that the server 32 perform certain functions appropriate for the agency's purpose, and the server 32 then performs these functions.

If the agency wants to review or track inspection results, then the server 32 retrieves the data in the database 106 (FIG. 6). The server 32 then provides the data to the agency computer 36. In this and certain other embodiments, if the agency then wants to analyze the data or use the data for another analysis, the agency requests that the server 32 execute software to arrange or configure the data as desired, or to perform the analysis. Then at step 122 the server executes the appropriate software to perform the requested arrangement, configuration or analysis. Once finished, the server 32 then provides the agency computer 36 the results of the arrangement, configuration or analysis. Thus, the server 32 stores and executes software that the agency can use to asses compliance and perform other analyses. Then, at step 124, the server 32 notifies the appropriate entity affected by the results of the arrangement, configuration or analysis.

Other embodiments are possible. For example, the server 32 can provide the agency computer 36 the data that the agency requests, and the agency computer 36, not the server 32, can store and execute software that the agency can use to assess compliance and perform other analyses.

If the agency wants to update data used to dynamically generate an inspection report, then the agency computer 36 provides the server 32 the updated data. The server 32 then retrieves from the appropriate database the data that is no longer current and adds the updated data to the database in the place of the outdated data.

FIG. 8 is a flowchart of a process for a manufacturer of a device or system to review and update the data used to dynamically generate an inspection report, according to an embodiment of the invention. In this and certain other embodiments, the review and update process begins when the manufacturer computer 40 (FIG. 2) communicates with the server 32 (FIG. 2) at step 130. After communication has been established, the manufacturer requests that the server 32 perform certain functions appropriate for the manufacturer's purpose, and the server 32 then performs these functions. If the manufacturer wants to review the data associated with the specific device or system made by the manufacturer, then the server 32 retrieves and provides the data to the manufacturer computer 40.

If the manufacturer wants to update the data associated with the specific device or system made by the manufacturer, then the manufacturer computer 40 provides the server 32 the updated data. The server 32 at step 132 then retrieves from the appropriate database the data that is no longer current and adds the updated data to the database in the place of the no longer current data.

If the updated data from the agency directly conflicts with the updated data from the manufacturer, then the updated data from the manufacturer is used by the report generator 42 (FIG. 2) to dynamically generate an inspection report. An example of data that directly conflicts is data that identifies the flow rate of a pump. The agency might request that the flow rate not exceed a certain level, and the manufacturer might indicate that the pump can provide a flow rate greater than the maximum level requested by the agency.

From the foregoing, it will be appreciated that, although specific embodiments have been discussed herein for purposes of illustration, various modifications may be made without deviating from the spirit and scope of the discussion herein. Accordingly, the systems and methods include such modifications as well as all permutations and combinations of the subject matter set forth herein and are not limited except as by the appended claims.

What is claimed is:

1. A method for managing information generated from an environmental inspection, the method comprising:
retrieving, from a database, a first type of data that identifies the location of an environmental site, and at least one of the following subjects located and to be inspected at the site:
a device,
a system, and
an environmental element,
retrieving, from a database, a second type of data that identifies information to be obtained from the inspection;
dynamically generating an inspection report that includes the first type of data and the second type of data; and
providing the inspection report to an inspector to facilitate the inspector's inspection of the environmental site.

2. The method of claim 1 wherein:
retrieving both types of data includes retrieving them from a single database;
and
generating an inspection report includes comparing the retrieved data that identifies information to be obtained from the inspection with data from a second database that identifies the information currently required to be obtained from the inspection.

3. The method of claim 1 wherein:
retrieving the first type of data includes retrieving the data from a first database,
retrieving the second type of data includes retrieving data from a second database that identifies the information currently required to be obtained from the inspection, and
dynamically generating the inspection report includes combining the first type of data with the second type of data.

4. The method of claim 1 wherein the inspection report is dynamically generated before the inspector arrives at the environmental site.

5. The method of claim 1 wherein the inspection report is dynamically generated after the inspector arrives at the environmental site, before the inspector completes the inspection at the site, and in response to an update of at least one of the two types of data.

6. The method of claim 1 further comprising updating the data.

7. The method of claim 1 wherein the second type of data includes information from at least one of the following sources:
a regulation of the jurisdiction in which the site is located, and
a design of the device.

8. The method of claim 1 wherein the environmental element includes water.

9. The method of claim 1 wherein the device includes a septic tank.

10. The method of claim 1 further comprising:
receiving information obtained from the inspector's inspection of the environmental site; and
storing the information.

11. The method of claim 1 further comprising:
receiving information obtained from the inspector's inspection of the environmental site; and
validating the information.

12. The method of claim 1 further comprising:
receiving information obtained from the inspector's inspection of the environmental site; and
comparing the information with acceptable, predetermined limits to determine the acceptance or failure of a device's performance or an environmental element's constitution.

13. The method of claim 1 further comprising notifying at least one of the following entities:
an owner of the environmental site,
a possessor of the environmental site,
a manufacturer of a device or system inspected at the environmental site,
the regulatory agency responsible for administering compliance of environmental regulations, and
the inspector who inspected the environmental site.

14. A method for inspecting an environmental site, the method comprising:
retrieving an inspection report that is dynamically generated from data that identifies the location of the environmental site, and at least one of the following subjects of the inspection located at the environmental site:
a device,
a system, and
an environmental element,
and from data that identifies information to be obtained from an inspection of the environmental site.

15. The method of claim 14 further comprising reviewing the one or more subjects located at the site.

16. The method of claim 14 further comprising:
reviewing the one or more subjects located at the site; and
recording the information obtained from the review;

17. The method of claim 16 wherein recording the information includes uploading the information to a computer.

18. The method of claim 17 wherein uploading the information includes communicating with the computer over the internet.

19. The method of claim 14 further comprising:
reviewing the one or more subjects located at the site;
updating the data that identifies the one or more subjects located and to be inspected at the site;
retrieving another inspection report that includes the updated data and current, corresponding data that identifies the information to be obtained from the inspection;
completing the inspection; and
recording the information obtained from the inspection

20. A method for tracking compliance with environmental regulations, the method comprising:
reviewing dynamically generated inspection reports that include:
data that identifies the location of the environmental site inspected, the one or more subjects inspected at the site, and
data that identifies information obtained from the inspection of the site.

21. A computer-readable storage medium storing a program that, when executed by a computer generates an inspection report that an inspector can use to facilitate an inspection of an environmental site by performing operations comprising:
retrieving, from a database, a first type of data that identifies the location of an environmental site, and at least one of the following subjects located and to be inspected at the site:
a device,
a system, and
an environmental element,
retrieving, from a database, a second type of data that identifies information to be obtained from an inspection of the environmental site;
dynamically generating an inspection report that includes:
the first type of data, and
the second type of data; and
providing the inspection report to an inspector to facilitate the inspector's inspection of the environmental site.

22. A computer system comprising:
a database that includes a first type of data that identifies the location of an environmental site, and at least one of the following subjects located and to be inspected at the site:
a device,
a system, and
an environmental element,
a database that includes a second type of data that identifies information to be obtained from an inspection of the environmental site; and
a report generator operable to retrieve:
the first type of data, and
the second type of data
and operable to combine the first type of data with the second type of data to dynamically generate an inspection report to facilitate an inspector's inspection of the environmental site.

23. A computer network comprising:
a server system including:
a database that includes a first type of data that identifies the location of an environmental site, and at least one of the following subjects located and to be inspected at the site:
a device,
a system, and
an environmental element,
a database that includes a second type of data that identifies information to be obtained from an inspection of the environmental site,
a report generator operable to retrieve:
the first type of data, and
the second type of data,
and operable to combine the first type of data with the second type of data to dynamically generate an inspection report to facilitate an inspector's inspection of the environmental site; and
a client system operable to communicate with the server.

24. The computer network system of claim 23 wherein the client system communicates with the server system via the internet.

25. The computer network system of claim 23 wherein the client system includes an agency computer.

26. The computer network system of claim 23 wherein the client system includes an inspector computer.

27. The computer network system of claim 23 wherein the client system includes a manufacturer computer.
